(19) United States
(12) Patent Application Publication
(10) Pub. No.: US 2004/0120240 A1
(43) Pub. Date: Jun. 24, 2004

(54) Optical information storage medium and method of recording data thereon

(75) Inventors: Kyung-Geun Lee, Gyeonggi-do (KR); In-Sik Park, Gyeonggi-do (KR); Du-Seop Yoon, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD

(21) Appl. No.: 10/624,634

(22) Filed: Jul. 23, 2003

(30) Foreign Application Priority Data
Jul. 23, 2002 (KR) 2002-43397

(51) Int. Cl. G11B 7/125; G11B 7/24

(52) U.S. Cl. 369/59.25; 369/275.3; 369/47.51

(57) ABSTRACT

An optical information storage medium and a method of recording data on the optical information storage medium are provided. In the optical information storage medium, a reproduction-only area and a recordable area are included in an area other than a user data area. Every time user data is completely recorded, new data about a disk state is recorded in the recordable area. Due to the structure of the optical information storage medium, every time user data is completely recorded, recent data about a disk state is recorded. Thus, when new data is recorded, a pickup can rapidly access an accurate area in which the new data is to be recorded.

### CROSS-REFERENCE TO RELATED APPLICATION

This application claims the benefit of Korean Patent Application No. 2002-43397, filed on Jul. 23, 2002, in the Korean Intellectual Property Office, the disclosure of which is incorporated herein by reference.

### BACKGROUND OF THE INVENTION

1. Field of the Invention

The present invention relates to an optical information storage medium on which information about the state of a disk is newly recorded every time recording of user data is completed, and a method of recording data on the optical information storage medium.

2. Description of the Related Art

General information storage media are widely used as information recording media of optical pickup apparatuses for recording/reproducing information in a non-contact way. Optical disks, which are information storage media, are classified as compact disks (CDs) or digital versatile disks (DVDs) according to their information storage capacity. Examples of recordable optical disks are 650 MB CD-R, CD-RW, 4.7 GB DVD/RW, DVD-RAM, and the like. Furthermore, HD-DVDs having a recording capacity of 20 GB or greater are under development.

In particular, write-once information storage media, among recordable optical information storage media, are usually used as backup optical information storage media for PCs or as audio/video (A/V) optical information storage media. User data is recorded on write-once information storage media in order of physical addresses, and data is no longer recorded on a physical address at which data has already been recorded. Accordingly, when recording is stopped and then resumed, data will be recorded on an area next to the area containing the most recently recorded data. As described above, write-once information storage media requires a new physical data structure having characteristics different from those of rewritable optical information storage media.

### SUMMARY OF THE INVENTION

One aspect of the present invention provides an optical information storage medium in which data about a recent disk state is newly recorded upon every data recording so that an area in which new data is to be recorded can be rapidly accessed by a pickup using the recorded disk state data, and a method of recording data on the optical information storage medium.

According to an aspect of the present invention, there is provided an optical information storage medium in which a reproduction-only area and a recordable area are included in an area other than a user data area, and new data about a disk state is recorded in the recordable area every time recording of user data is stopped.

According to one aspect of the invention, the data about a disk state includes at least one datum selected from the group consisting of the address of an area containing newly recorded optimum power control (OPC) data, the address of an area containing the most recently recorded drive data, the address of an area containing the most recently recorded user data, and data representing whether additional recording after recording of user data is possible.

According to one aspect of the invention, the data about a disk state is recorded in the recordable area of a lead-in area.

According to one aspect of the invention, the data about a disk state is updated, and new data about a disk state is recorded in an area next to the area containing the most recently recorded disk state data.

According to another aspect of the present invention, there is provided a method of recording data on an optical information storage medium in which a reproduction-only area and a recordable area are included in the area other than a user data area. This method includes recording user data, and recording new data about a disk state in the recordable area every time recording of user data is stopped.

Additional aspects and advantages of the invention will be set forth in part in the description which follows and, in part, will be obvious from the description, or may be learned by practice of the invention.

### BRIEF DESCRIPTION OF THE DRAWINGS

These features, and/or other aspects and advantages of the invention will become apparent and more readily appreciated from the following description of the preferred embodiments taken in conjunction with the accompanying drawings in which:

FIG. 1 schematically shows the data structure of an optical information storage medium according to one aspect of the present invention;

FIG. 2A shows disk state data recorded on an optical information storage medium according to one aspect of the present invention; and

FIG. 2B is a view for explaining a method of recording disk state data on an optical information storage medium according to one aspect of the present invention.

### DETAILED DESCRIPTION OF THE INVENTION

Reference will now be made in detail to the preferred embodiments of the present invention, examples of which are illustrated in the accompanying drawings, wherein like reference numerals refer to the like elements throughout. The embodiments are described below in order to explain the present invention by referring to the figures.

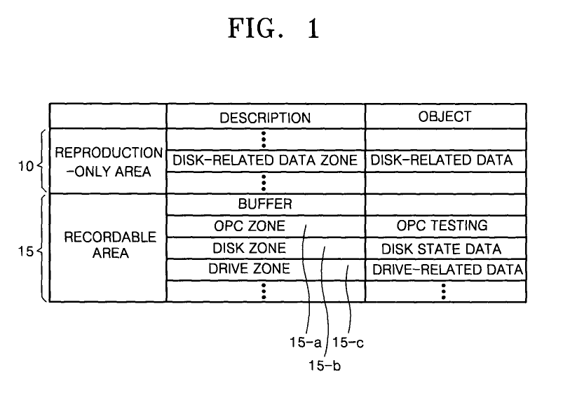

Referring to FIG. 1, an optical information storage medium according to one aspect of the present invention includes a reproduction-only area 10 and a recordable area 15 in the area other than a user data area. For example, the area other than a user data area can be a lead-in area located on the inner side of the user data area in the radial direction of a disk. The reproduction-only area 10 stores disk-related data, such as, the type, version number, size of a disk, the number of layers, and the like. This data is already recorded on a substrate in the form of pits or groove wobbles upon the manufacture of a disk and accordingly is only reproduced.

The recordable area 15 includes an optimum power control (OPC) zone 15-a for recording data used for optimal power control, a disk zone 15-b for recording data about disk states, and a drive zone 15-c for recording drive-related data. Examples of the disk state data include the address of an area containing new OPC data, the address of an area where the last drive information has been recorded, the address of an area where the last user data has been recorded, and data representing whether additional recording is possible, or impossible, after user data is recorded. According to one aspect of the present invention, at least one of these disk state data is recorded on the disk zone 15-b.

The OPC zone 15-a records data about recording and/or reproduction power, which is used to record and/or reproduce user data, every time the user data is stopped. The recording and/or reproduction power can be optimally controlled based on the data about recording and/or reproduction power. Every time recording is performed, new data about power, which is used during recording, is recorded. In write-once optical information storage media, every time new recording is performed, OPC data is recorded on a new area where data is not recorded. Accordingly, when recording is completed and then new recording is executed, an area on which new OPC data is to be recorded must be searched for. According to one aspect of the present invention, the address of the area containing the newly recorded OPC data is recorded in a predetermined area so as to enable a rapid access. That is to say, the address of an area containing the most recently recorded OPC data is recorded on the disk zone 15-b. Upon new data recording, new OPC data can be rapidly accessed by only reproducing the address of the area containing the most recently recorded OPC data without a need to reproduce all of the OPC areas.

The drive zone 15-c records drive-related data, such as, data about a drive manufacturer or the serial number of a drive. Every time recording is executed, data about a drive that performs the recording is newly recorded. Hence, according to one aspect of the present invention, the address of an area containing the most recently recorded drive data is recorded as the disk state data. Accordingly, when new drive data is recorded, a position where the new drive data is to be recorded can be easily searched for by reproducing the recorded address of the area containing the most recently recorded drive data.

When recording of user data is interrupted and new data is recorded, a pickup must access an area where the new data is to be recorded. To achieve a rapid access, according to one aspect of the present invention, the address of the area containing the most recently recorded user data is recorded in a predetermined area.

As described above, if recent disk-related data is not provided, the OPC zone 15-a, the drive zone 15-c, or the user data area is entirely read upon recording of user data. Thus, significantly much time is taken to access an area in which the user data is to be recorded.

According to one aspect of the present invention, after recording of user data is completed, data representing whether additional data can be recorded on an area next to the area containing the finally recorded user data is recorded. In order to prevent further recording, data representing the impossibility of additional recording after completion of recording is recorded. On the other hand, if additional recording can be performed, data representing the possibility of additional recording after the completion of recording is recorded.

Every time data recording is completed, such disk state data is recorded in a predetermined area, for example, the disk zone 15-b, of the recordable area 15 included in a lead-in area. When new data is recorded, a pickup can accurately and rapidly access an area where the new data is to be recorded, using the recorded disk state data. One aspect of the present invention is effectively applicable to write-once optical information storage media.

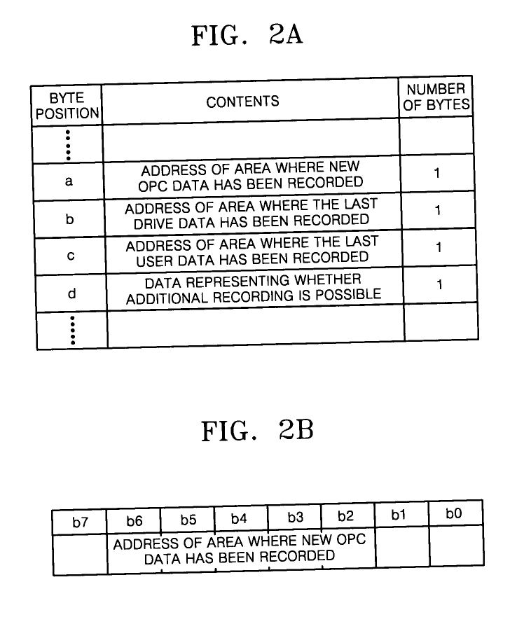

When disk state data are recorded, each datum can be recorded in at least one byte of the disk zone 15-b. Examples of bytes, which record disk state data, include the bytes of a physical cluster, the bytes of an ECC block, or the bytes of a sector. Referring to FIG. 2A, the address of an area containing newly-recorded OPC data is recorded in an a-th byte, the address of an area containing the most recently recorded drive data is recorded in a b-th byte, and the address of an area containing the most recently recorded user data is recorded in a c-th byte. Also, data about whether additional recording is possible, or impossible, after the completion of recording can be recorded in a d-th byte. Each of these disk state data may be recorded in one byte as shown in FIG. 2A, or may be recorded in two or more bytes.

As shown in FIG. 2B, a byte is comprised of seventh through zeroth bits, i.e., b7 through b0. If the address of an area containing newly recorded OPC data is recorded in one byte, it can be represented as a combination of bits. For example, the address can be recorded in the form of 0001b, 0010b, or 001b using the seventh through fourth bits b7 through b4.

Likewise, the address of an area containing the finally recorded drive data and the address of an area containing the finally recorded user data can be recorded in different bytes. For example, in the recording of the data about the possibility or impossibility of additional recording, 00000000b can be recorded to represent the possibility of additional recording, and 00000001b can be recorded to represent the impossibility of additional recording.

The disk state data according to one aspect of the present invention is updated every time user data is recorded. According to one aspect of the present invention, the disk state data is updated in such a way that new disk state data is recorded in an area having no recorded data. In other words, disk state data are recorded in different areas so as to prevent duplicate recording of data in the same area. According to another aspect of the present invention, new disk state data is recorded in an area next to the area containing the most recently recorded data. Each of the disk zone 15-b and the drive zone 15-c is comprised of 1000 or more physical clusters.

In an optical information storage medium according to one aspect of the present invention, a reproduction-only area and a recordable area are included in the area other (e.g., a lead-in area) than a user data area. In a method of recording data on the optical information storage medium according to one aspect of the present invention, recent data about disk states is recorded in the recordable area. User data is first recorded, and every time the user data is completely recorded, disk state data is newly recorded in the recordable area. If new disk state data is recorded, it is recorded in an area next to the area containing the most recently recorded disk state data.

Examples of the disk state data include the address of an area containing newly recorded OPC data, the address of an area containing finally recorded drive data, the address of an area containing finally recorded user data, and data representing whether additional recording after recording of user data is possible. According to one aspect of the present invention, at least one of these is recorded as the disk state data. In addition, the address of an area, in which new control data is recorded every time user data recording is completed, is recorded as the disk state data.

As described above, in an optical information storage medium according to one aspect of the present invention and a method of recording data on the optical information storage medium, every time user data recording is completed, recent data about a disk state is recorded. Thus, when new data is recorded, a pickup can accurately and rapidly access an area where the new data is to be recorded. Also, because the user data can be recorded using the recent data about a disk state, recording and/or reproduction performance can be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical information storage medium, comprising:
a user data area; and
an area other than the user data area, comprising:
a reproduction-only area; and
a recordable area wherein new data about a disk state is recorded in the recordable area every time a recording of user data is stopped.

2. The optical information storage medium according to claim 1, wherein the new data about the disk state is at least one datum selected from an address of an area containing newly recorded optimum power control data, an address of an area containing most recently recorded drive data, and an address of an area containing most recently recorded user data, and data representing whether an additional recording after the recording of user data is possible.

3. The optical information storage medium according to claim 2, wherein the new data about the disk state is recorded in the recordable area of a lead-in area.

4. The optical information storage medium according to claim 2, wherein when data about the disk state is updated, the new data about the disk state is recorded in an area next to an area containing most recently recorded disk state data.

5. The optical information storage medium according to claim 4, wherein the new data about the disk state is recorded as a combination of bits of at least one byte.

6. The optical information storage medium according to claim 1, wherein the recordable area where the new data about the disk state is recorded is a lead-in area.

7. The optical information storage medium according to claim 1, wherein when data about the disk state is updated, the new data about the disk state is recorded in an area next to an area containing most recently recorded disk state data.

8. A method of recording data on an optical information storage medium in which a reproduction-only area and a recordable area are included in an area other than a user data area, the method comprising:
recording user data; and
recording new data about a disk state in the recordable area every time recording of user data is stopped.

9. The method according to claim 8, wherein the new data about the disk state is at least one datum selected from an address of an area containing newly recorded optimum power control data, an address of an area containing most recently recorded drive data, and an address of an area containing most recently recorded user data, and data representing whether an additional recording after the recording of user data is possible.

10. The method according to claim 9, wherein the new data about the disk state is recorded in the recordable area of a lead-in area.

11. The method according to claim 9, wherein when data about the disk state is updated, recording the new data about the disk state in an area next to an area containing most recently recorded disk state data.

12. The method according to claim 11, wherein the new data about the disk state is recorded as a combination of bits of at least one byte of the recordable area.

13. The method according to claim 8, wherein the new data about the disk state is recorded in the recordable area of a lead-in area.

14. The method according to claim 8, wherein when data about the disk state is updated, the new data about the disk state is recorded in an area next to an area containing a most recently recorded disk state data.

15. The optical information storage medium according to claim 1, the recordable area comprising:
an optimum power control zone recording data for optimal power control;
a disk zone recording data about the disk states; and
a drive zone recording drive-related data.

16. The optical information storage medium according to claim 15, wherein each of the disk zone and the drive zone is comprised of 1000 or more physical clusters.

17. The method according to claim 8, the recording of new data comprising:
recording data for optimal power control in an optimum power control zone,
recording data about the disk states in a disk zone, and
recording drive-related data in a drive zone.

18. The method according to claim 8, wherein each of the disk zone and the drive zone is comprised of 1000 or more physical clusters.

19. An optical information storage medium, comprising:
a user data area;
a reproduction-only area; and
a recordable area, where the recordable area comprises:
an optimum power control zone recording data for optimal power control,
a disk zone recording data about a disk state every time a recording of user data is stopped, and
a drive zone recording drive-related data.

20. The optical information storage medium according to claim 19, wherein an address of an area containing newly recorded optimum power control data is recorded in a predetermined area of the recordable area.

21. The optical information storage medium according to claim 19, the data about the disk state, comprising:
address of an area containing new optimum power control data,
address of an area where the last drive information has been recorded,
address of an area where the last user data has been recorded, and
data representing whether additional recording is possible after the user data is recorded.

22. A method of accessing an area on an optical storage medium where new data is to be recorded, comprising:
predetermining a recordable area of the optical storage medium;
recording an address of an area containing most recently recorded data in a predetermined area; and
reproducing the recorded address of the area containing the most recently recorded drive data.

23. The method according to claim 22, wherein the most recently recorded data is at least one of user data and drive data.

24. The method according to claim 22, further comprising recording data representing at least one of a possibility and an impossibility of additional recording in the predetermined area.

25. The recordable area of an optical information storage medium, comprising:
an optimum power control zone recording data for optimal power control;
a disk zone recording data about a disk state every time a recording of user data is stopped; and
a drive zone recording drive-related data.

26. The recordable area of an optical information storage medium according to claim 25, wherein both the disk zone and the drive zone are comprised of 1000 or more physical clusters.

27. The recordable area of an optical information storage medium according to claim 25, wherein the disk state data comprises:
an address of an area containing newly recorded optimum power control data,
an address of an area containing finally recorded drive data,
an address of an area containing finally recorded user data, and
data representing whether additional recording after recording of user data is possible.

28. A method of organizing a recording of updated data on an optical information storage medium, comprising:
recording new disk state data in a different area then present disk state data; and
recording data representing the possibility of additional recording after completion of recording is recorded,
wherein new data about a disk state is recorded in the recordable area every time a recording of user data is stopped.

29. The method of organizing the recording of updated data according to claim 28, wherein the different area is an area next to the area containing most recently recorded data.
